(19) United States
(12) Patent Application Publication
(10) Pub. No.: US 2014/0053012 A1
(43) Pub. Date: Feb. 20, 2014

(54) SYSTEM AND DETECTION MODE

(71) Applicant: FUJITSU LIMITED, Kawasaki-shi (JP)

(72) Inventors: Koichiro Yamashita, Hachioji (JP); Hiromasa Yamauchi, Kawasaki (JP); Takahisa Suzuki, Yokohama (JP); Koji Kurihara, Kawasaki (JP)

(73) Assignee: FUJITSU LIMITED, Kawasaki-shi (JP)

(21) Appl. No.: 14/063,659

(22) Filed: Oct. 25, 2013

Related U.S. Application Data
(63) Continuation of application No. PCT/JP2011/060190, filed on Apr. 26, 2011.

(51) Int. Cl. G06F 11/30

(52) U.S. Cl. CPC G06F 11/302; G06F 11/3058
USPC 713/340

(57) ABSTRACT

A system includes a CPU; a sensor that detects power of the CPU; a cache memory state monitoring circuit that monitors a state of a cache memory; and a detection circuit that based on a sensor signal from the sensor and a state signal from the cache memory state monitoring circuit, detects a spin state of a program executed by the CPU.

### CROSS REFERENCE TO RELATED APPLICATIONS

This application is a continuation application of International Application PCT/JP2011/060190, filed on Apr. 26, 2011 and designating the U.S., the entire contents of which are incorporated herein by reference.

### FIELD

The embodiments discussed herein are related to a system and a detection method for detecting spin state.

### BACKGROUND

When software is run in multiple threads, a process may be executed conventionally while executing a synchronization process or providing exclusion control. A method of explicitly using a certain instruction in the synchronization process and the exclusion control includes a mutex suspending/canceling a barrier synchronization instruction utilizing a hardware function such as a central processing unit (CPU) or a thread that is a library of an operating system (OS). Non-explicit exclusion control includes an implementing method based on a state transition wait by monitoring of a flag, for example.

Such a synchronization process and exclusion control cause a decrease in system processing ability because software repeats the same process without advancing processing although the process is executed in terms of hardware. A state of repeating the same process as described above will hereinafter be defined as a spin state. A CPU falling into the spin state consumes more power. Therefore, techniques of detecting the spin state and avoiding the spin state have been disclosed.

A technique of detecting the spin state is disclosed as, for example, a technique of detecting a spin-wait instruction indicative of looping during a program. Another technique of detecting the spin state is disclosed as, for example, a technique of predicting a loop of an instruction example by using statistical information so as to detect the spin state. A scheduling technique in the case of detection of the spin state is disclosed as, for example, a technique of saving and restoring an operation state when the spin state is detected. A technique also exists that assigns another thread to a CPU when a thread falling into the spin state exists (see, e.g., Published Japanese-Translation of PCT Application, Publication No. 2003/040948, Japanese Laid-Open Patent Publication Nos. 2006-40142, 2009-116885, and H5-204675).

However, since the spin state is detected by referring to an explicitly described spin-wait instruction in the conventional techniques, it is problematically difficult to detect a spin state that is consequent to a loop not explicitly described in a program. For example, since an instruction group of a program performing a state transition wait by the monitoring of a flag does not include an instruction utilizing a hardware function of a CPU or an instruction calling a library of an OS, the instruction group does not include an instruction acting as a mark indicating that a corresponding program causes the spin state. Therefore, it is difficult for conventional techniques to detect that such a program causes the spin state.

The conventional techniques enable prediction of a non-explicit spin state to some degree by using statistical information. However, the spin state cannot be detected in a place where the spin state does not occur during collection of the statistical information and therefore, it is problematically difficult to detect all the non-explicit spin states.

### SUMMARY

According to an aspect of an embodiment, a system includes a CPU; a sensor that detects power of the CPU; a cache memory state monitoring circuit that monitors a state of a cache memory; and a detection circuit that based on a sensor signal from the sensor and a state signal from the cache memory state monitoring circuit, detects a spin state of a program executed by the CPU.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view of an operation example of a multi-core processor system 100;

FIG. 2 is a block diagram of a hardware configuration of the multi-core processor system according to the embodiment;

FIG. 3 is a block diagram of hardware and software examples around a CPU of the multi-core processor system 100;

FIG. 4 is a block diagram of a hardware example of a spin avoidance mechanism 104;

FIG. 5 is a block diagram of an example of spin state detection by a spin determining unit 402;

FIG. 6 is a block diagram of an example of spin state cancelation detection by the spin determining unit 402;

FIG. 7 is an explanatory view of an operation example of a cache memory state monitoring circuit 403;

FIGS. 8A, 8B, and 8C are explanatory views of an example of a power consumption state in a spin state;

FIG. 9 is an explanatory view of an example of a determining method of the timing of elimination of the spin state;

FIG. 10 is a sequence diagram of an example of spin state detection determination;

FIG. 11 is a sequence diagram of an example of spin state cancelation determination;

FIG. 12 is a flowchart of an example of spin state periodicity determination process by a spin avoidance mechanism driver 412; and

FIG. 13 is a flowchart of an example of a thread save/restore process by a dispatch scheduler 324.

### DESCRIPTION OF EMBODIMENTS

Preferred embodiments of a system and a detection method will be explained with reference to the accompanying drawings. As an example of the system, description will be given of a multi-core processor system having plural central processing units (CPUs). The multi-core processor system is a processor equipped with multiple cores. The multiple cores may be provided as a single processor equipped with multiple cores or a group of single-core processors connected in parallel. For the sake of convenience, in the embodiments, description will be given taking a group of single core processors connected in parallel as an example.

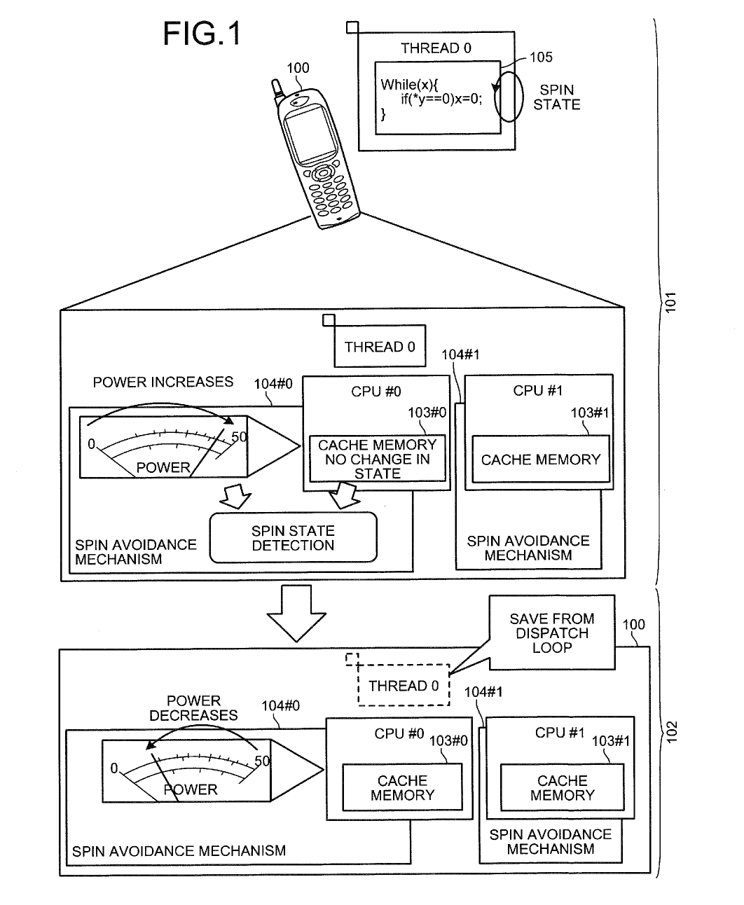

FIG. 1 is an explanatory view of an operation example of a multi-core processor system 100. The multi-core processor system 100 depicted in FIG. 1 includes a CPU #0 and a CPU #1. A reference numeral accompanied by a suffix “#n” hereinafter indicates the reference numeral that corresponds to an n-th CPU. The multi-core processor system 100 is assumed to be a mobile terminal such as a mobile telephone. A portion denoted by reference numeral 101 depicts a state in which the CPU #0 is put into a spin state and a portion denoted by reference numeral 102 depicts a case where the CPU #0 that is in the spin state is canceled and enters a non-spin state. The CPU #0 and the CPU #1 include cache memory 103#0 and cache memory 103#1, respectively. The CPU #0 and CPU #1 respectively include a spin avoidance mechanism 104#0 and a spin avoidance mechanism 104#1 that detect the occurrence of a spin state.

In the portion depicted by reference numeral 101, the CPU #0 executes a thread 0 that includes execution code 105. The execution code 105 has an algorithm of waiting for the rewrite of a value of *y before exiting a loop. In the case of such an algorithm, if exclusive synchronization is achieved by a dedicated instruction such as a mutex, the compiler can recognize an explicit locked state. However, if coding such as the execution code 105 is performed, the compiler, etc. cannot determine whether this causes a spin state.

If the execution of the thread 0 causes the CPU #0 to enter a spin state, power of the CPU #0 increases. Since the same process is repeated, the state of the cache memory 103#0 does not change. The spin avoidance mechanism 104#0 detects the spin state from the power of the CPU #0 and the state of the cache memory 103#0. As described above, by using the state of the multi-core processor system 100 in the spin state for detection, the spin avoidance mechanism 104#0 can detect a spin state that is consequent to exclusive control implemented without using a special instruction for exclusive control.

The portion denoted by reference numeral 102 depicts the state of the multi-core processor system 100 after the detection of the spin state. As a result of the detection of the spin state by the spin avoidance mechanism 104#0, the CPU #0 can easily identify the thread 0 in the spin state without explicit description of exclusive control in a program. Therefore, the CPU #0 saves the identified thread 0 from a dispatch loop. As a result, the power of the CPU #0 is reduced and therefore, the multi-core processor system 100 can reduce power consumption.

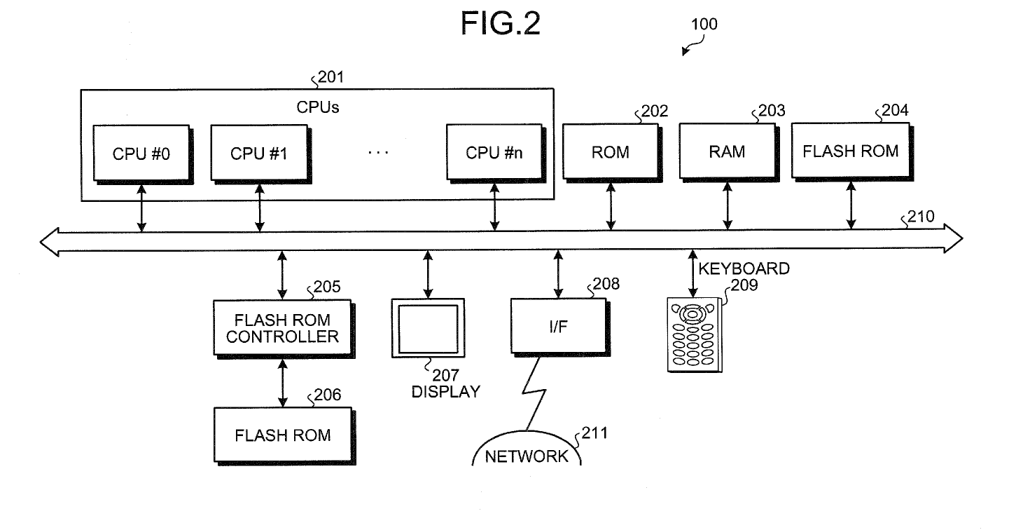

FIG. 2 is a block diagram of a hardware configuration of the multi-core processor system according to the embodiment. As depicted in FIG. 2, a multi-core processor system 200 includes multiple central processing units (CPUs) 201, read-only memory (ROM) 202, random access memory (RAM) 203, flash ROM 204, a flash ROM controller 205, and flash ROM 206. The multi-core processor system includes a display 207, an interface (I/F) 208, and a keyboard 209, as input/output devices for the user and other devices. The components of the multi-core system 200 are respectively connected by a bus 210.

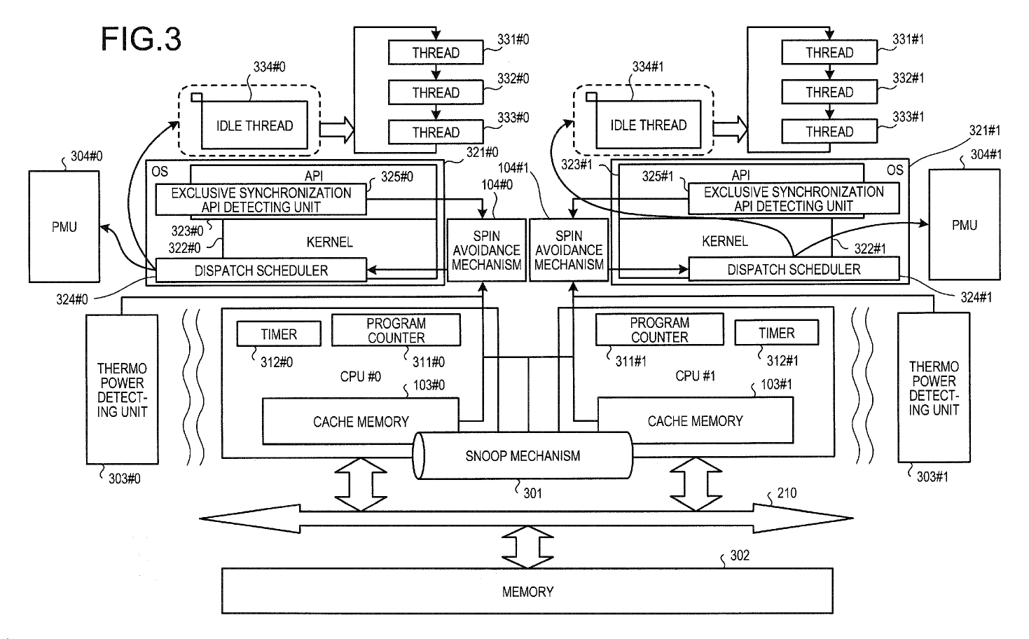

The CPUs 201 govern overall control of the multi-core processor system 200. The CPUs 201 include CPUs #0 to #n, where n is an integer of 1 or more. The CPUs #0 to #n respectively have the cache memory 103 and the spin avoidance mechanism 104 depicted in FIG. 1 as well as other hardware. The hardware will be described hereinafter with reference to FIG. 3.

The ROM 202 stores therein programs such as a boot program. The RAM 203 is used as a work area of the CPUs 201. The flash ROM 204 enables high speed reading, such as NOR type flash ROM. The flash ROM 204 stores system software such as an operating system (OS), and application software. For example, when the OS is updated, the multi-core processor system 200 receives a new OS via the I/F 208 and updates the old OS that is stored in the flash ROM 204 with the received new OS.

The flash ROM controller 205, under the control of the CPUs 201, controls the reading and writing of data with respect to the flash ROM 206. The flash ROM 206 is flash ROM that stores data, has a primary purpose of portability, and may be, for example, NAND type flash ROM. The flash ROM 206 stores therein data written under control of the flash ROM controller 205. Examples of the data include image data and video data acquired by the user of the multi-core processor system through the I/F 208, as well as a program that executes the thread processing method according to the present embodiment. A memory card, SD card and the like may be adopted as the flash ROM 206.

The display 207 displays, for example, data such as text, images, functional information, etc., in addition to a cursor, icons, and/or tool boxes. A thin-film-transistor (TFT) liquid crystal display and the like may be employed as the display 207.

The I/F 208 is connected to a network 211 such as a local area network (LAN), a wide area network (WAN), and the Internet through a communication line and is connected to other apparatuses through the network 211. The I/F 208 administers an internal interface with the network 211 and controls the input and output of data with respect to external apparatuses. For example, a modem or a LAN adaptor may be employed as the I/F 208.

The keyboard 209 includes, for example, keys for inputting letters, numerals, and various instructions and performs the input of data. Alternatively, a touch-panel-type input pad or numeric keypad, etc. may be adopted.

FIG. 3 is a block diagram of hardware and software examples around the CPU of the multi-core processor system 100. First, the multi-core processor system 100 includes a snoop mechanism 301, a thermo power detecting unit 303, a power management unit (PMU) 304, and the spin avoidance mechanism 104 as hardware.

The snoop mechanism 301 is an apparatus that ensures the consistency of the cache memories 103 accessed by the CPUs #0 to #n. For example, if the cache memory 103#0 is updated, the snoop mechanism 301 notifies the cache memory 103#1 of update contents. Protocols of the snoop mechanism 301 include an invalidate protocol and an update protocol.

The apparatus ensuring the consistency of the cache memories 103 is classified as a cache coherency mechanism and an example of the cache coherency mechanism is a snoop mechanism. The cache coherency mechanism is broadly classified into a snoop mechanism employing a snoop mode and a directory mode. The snoop mechanism 301 according to this embodiment may be a cache coherency mechanism employing a directory mode.

A memory 302 is a shared storage device that can be accessed by the CPUs 201. The memory 302 may be the entire or a portion of the RAM 203. The memory 302 may include the ROM 202, the flash ROM 204, and the flash ROM 206.

Hardware and software other than the snoop mechanism 301 and the memory 302 described with reference to FIG. 3 are included in each of the CPUs #0 to #n. Therefore, in the following description of FIG. 3, hardware and software related to the CPU #0 will be described and the suffix “#0” will be omitted.

With regard to the hardware of the CPU #0, the CPU #0 includes a program counter 311, a timer 312, and a cache memory 103. With regard to the software executed by the CPU #0, the CPU #0 executes an OS 321, threads 331 to 333, and an idle thread 334. The OS 321 includes a kernel 322, an application programming interface (API) 323, a dispatch scheduler 324, and an exclusive synchronization API detecting unit 325.

The thermo power detecting unit 303 has a function of detecting power and temperature from a thermostat for temperature regulation associated with the CPU. The thermo power detecting unit 303 is not connected through wiring to the CPU and is physically connected on a substrate. A PMU 304 is an apparatus that manages power supply voltage and a clock of the CPU.

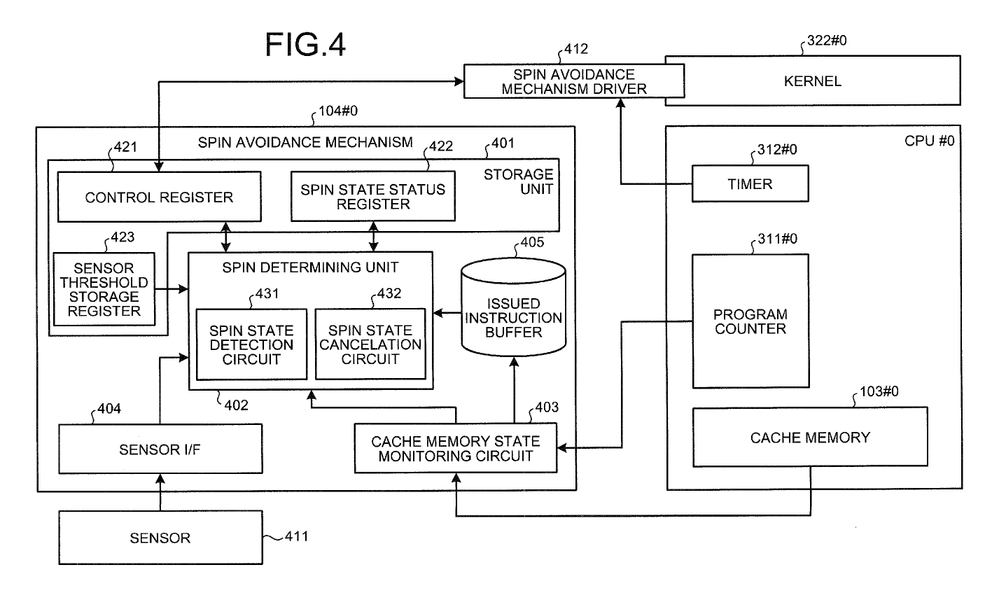

The spin avoidance mechanism 104 detects the spin state based on input from the thermo power detecting unit 303, the cache memory 103, and the exclusive synchronization API detecting unit 325. A detection result is output to the dispatch scheduler 324. A configuration of the spin avoidance mechanism 104 will be described later with reference to FIG. 4.

The program counter 311 is a register of the CPU and is a storage area storing an address of the memory 302 at which an instruction currently under execution by the CPU is stored. The timer 312 has a function of giving notification of the elapsed of time. The timer 312 is implemented by a clock counter, etc. of the CPU.

The cache memory 103 is a storage area to which a portion of data in the memory 302 is copied so as to enable high-speed access of the data in the memory 302 by the CPU. The cache memory 103 includes a data cache that stores data and an instruction cache that stores an instruction in a program.

The OS 321 is a program that controls the multi-core processor system 100. For example, the OS 321 manages the memory 302 and/or provides an app to a file system. The kernel 322 has a core function of the OS 321. For example, the kernel 322 includes device driver controlling hardware such as the flash ROM controller 205 and the keyboard 209.

The API 323 is an interface to enable the threads 331 to 333 to access a library provided by the OS 321. For example, the API 323 is provided as a function providing control of the file system, image processing, character control, etc.

The dispatch scheduler 324 has a function of controlling the assignment of threads. For example, the dispatch scheduler 324 determines the next thread to be assigned to the CPU and assigns the thread to the CPU. The threads assigned by the dispatch scheduler 324 are the threads 331 to 333 and the idle thread 334. When assigning the idle thread 334 to the CPU, the dispatch scheduler 324 notifies the PMU 304 to stop the supply of the clock to the CPU.

The exclusive synchronization API detecting unit 325 is an API that controls the spin avoidance mechanism 104. For example, the exclusive synchronization API detecting unit 325 includes an API that performs setting when the spin state occurs and an API that cancels the setting for the spin state.

The threads 331 to 333 perform a function in application software. For example, it is assumed that the application software is a video reproducing app. In this case, the thread 331 is a download thread for downloading from the network 211; the thread 332 is a decode thread for decoding according to a video codec; and the thread 333 is a rendering thread for displaying on the display 207. The idle thread 334 is a thread doing nothing. For example, the idle thread executes a NOP instruction.

A hardware example of the spin avoidance mechanism 104 will hereinafter be described with reference to FIGS. 4 to 6. In FIGS. 4 to 6, the spin avoidance mechanism 104#0 corresponding to the CPU #0 will be described as an example. The spin avoidance mechanisms 104#1 to 104#n are of equivalent hardware and therefore, will not be described. Furthermore, the suffix “#n” will be omitted.

FIG. 4 is a block diagram of a hardware example of the spin avoidance mechanism 104. The spin avoidance mechanism 104 includes a storage unit 401, a spin determining unit 402, a cache memory state monitoring circuit 403, a sensor I/F 404, and an issued instruction buffer 405. The spin avoidance mechanism 104 receives input from a sensor 411. The spin avoidance mechanism 104 is controlled by a spin avoidance mechanism driver 412 in the kernel 322.

The storage unit 401 is a register group that stores information and includes a control register 421, a spin state status register 422, and a sensor threshold storage register 423. The control register 421 has three fields including spin state setting, spin state cancelation setting, and spin state. The spin state setting field and the spin state cancelation setting field are set from the spin avoidance mechanism driver 412.

When it is indicated from the spin avoidance mechanism driver 412 that a spin state exists, the spin state setting field stores an identifier that indicates the existence of the spin state. For example, the spin state setting field stores TRUE when it is indicated that a spin state exists, and stores FALSE when not indicated. When it is indicated that an existing spin state has been canceled, the spin state cancelation setting field stores an identifier that indicates the cancelation. For example, the spin state cancelation setting field stores TRUE when it is indicated that a spin state is canceled, and stores FALSE when not indicated.

Based on a result determined by the spin determining unit 402, the spin state field stores an identifier that indicates whether the spin state exists. For example, the spin state field stores TRUE when the spin determining unit 402 determines that a spin state exists, and stores FALSE when the spin determining unit 402 determines that a non-spin state exists. The spin state field sends to the spin avoidance mechanism driver 412, an interrupt signal indicative of whether a spin state exits.

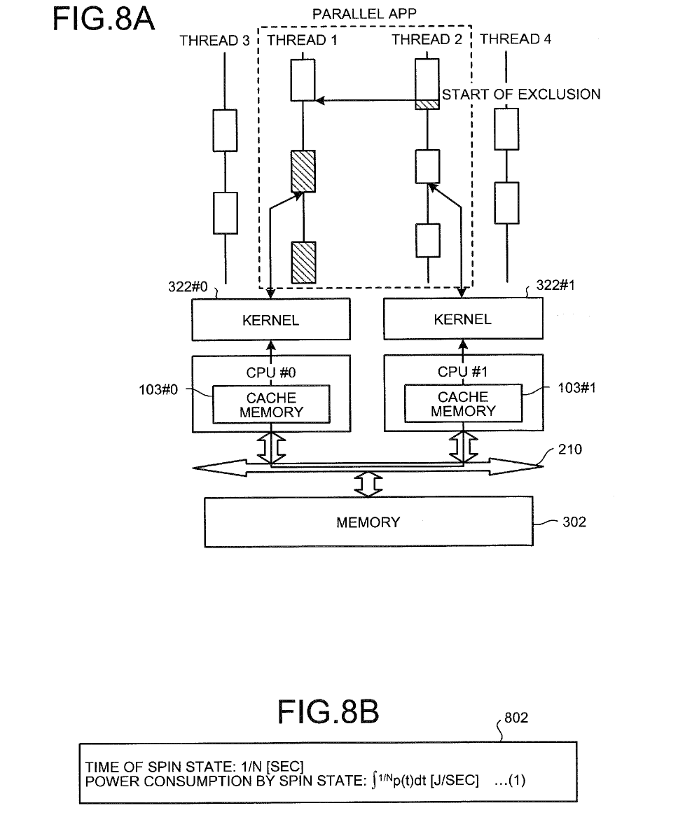

The spin state status register 422 is a register prepared for use inside the spin avoidance mechanism 104 to indicate whether a spin state or a non-spin state exists. For example, the spin state status register 422 stores TRUE in the case of a spin state and stores FALSE in the case of a non-spin state. The sensor threshold storage register 423 stores a threshold for a value of the sensor 411. A specific value of the threshold will be described later with reference to FIG. 8.

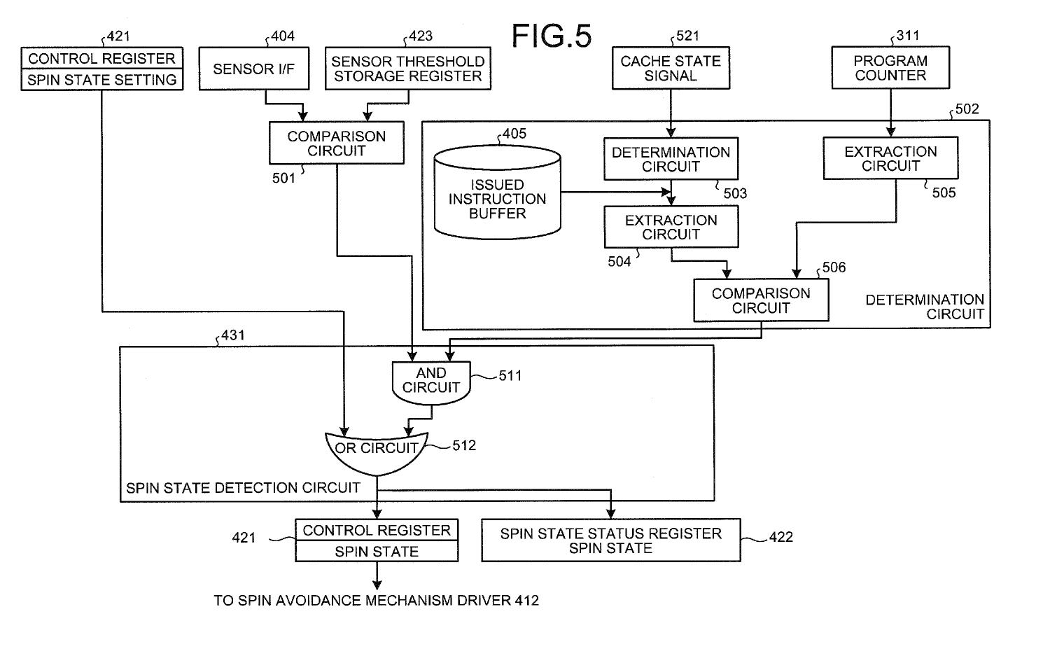

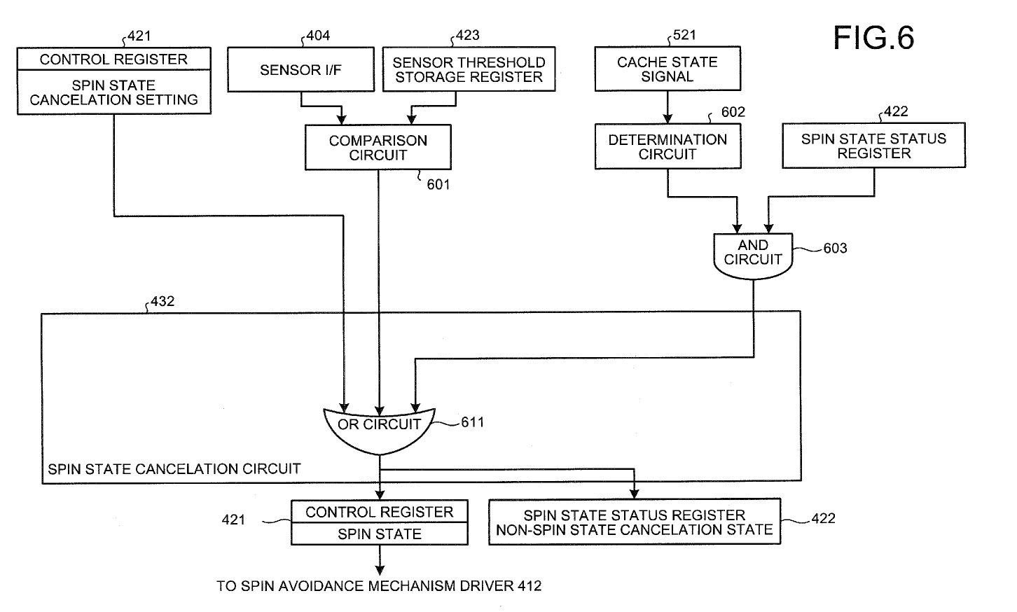

The spin determining unit 402 determines whether a spin state exists based on input from the control register 421, the sensor I/F 404, the sensor threshold storage register 423, the spin state status register 422, and the issued instruction buffer 405, and outputs the determination to the control register 421. The spin determining unit 402 includes a spin state detection circuit 431 that detects that a spin state exists, and a spin state cancelation circuit 432 that detects that a spin state has been canceled to be a non-spin state. Details of the spin state detection circuit 431 will be described later with reference to FIG. 5. Details of the spin state cancelation circuit 432 will be described later with reference to FIG. 6.

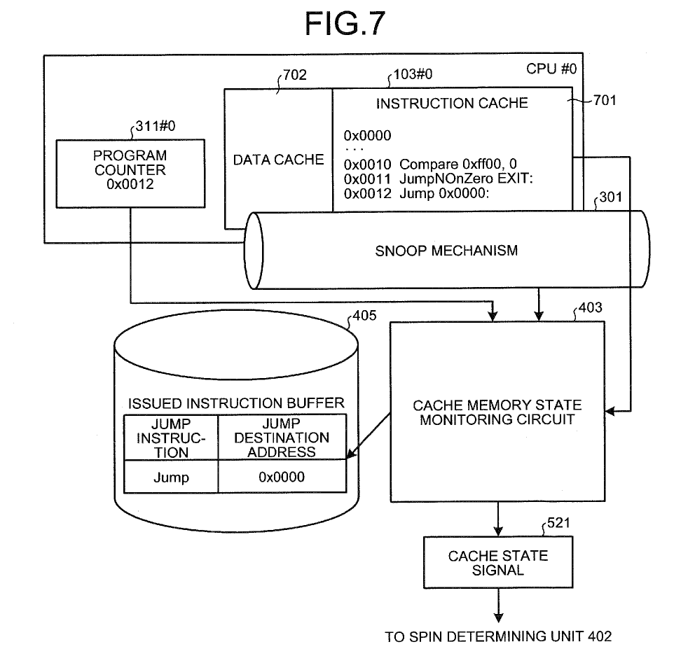

The cache memory state monitoring circuit 403 monitors the state of the cache memory 103. For example, the cache memory state monitoring circuit 403 uses the program counter 311#0 to acquire an instruction stored in the instruction cache in the cache memory 103 and stores the instruction into the issued instruction buffer 405. The cache memory state monitoring circuit 403 outputs to the spin determining unit 402, a state signal that indicates the state of the cache memory 103. The operation of the cache memory state monitoring circuit 403 will be described later with reference to FIG. 7. The sensor I/F 404 is an interface for the sensor 411. The sensor I/F 404 acquires an amount of electric power from the sensor 411 and outputs the amount as a sensor signal. The issued instruction buffer 405 accumulates the instructions executed by the CPU.

The sensor 411 is an electric power sensor such as the thermo power detecting unit 303. The sensor 411 may be a temperature sensor. The sensor threshold storage register 423 described above stores a threshold corresponding to the sensor 411.

The spin avoidance mechanism 412 is a driver that controls the spin avoidance mechanism 104. For example, the spin avoidance mechanism driver 412 performs writing to the spin state setting field and the spin state cancelation setting field. The spin avoidance mechanism driver 412 acquires at regular intervals according to the timer 312, an interrupt signal corresponding to the state of the spin state field to determine whether the spin state is in a deteriorated state and also determine whether the spin state has periodicity. The determination results are supplied to the dispatch scheduler 324.

FIG. 5 is a block diagram of an example of spin state detection by the spin determining unit 402. FIG. 5 depicts an example of a circuit used at the time of the spin state detection by the spin determination unit 402. The spin determining unit 402 uses the spin state detection circuit 431, a comparison circuit 501, and a determination circuit 502 to detect a spin state. The spin state detection circuit 431 includes an AND circuit 511 and an OR circuit 512. The determination circuit 502 includes a determination circuit 503, an extraction circuit 504, an extraction circuit 505, and a comparison circuit 506.

For the spin state detection, the spin determination unit 402 receives input from the control register 421, the sensor I/F 404, the sensor threshold storage register 423, a cache state signal 521 output from the cache memory state monitoring circuit 403, and the program counter 311. The spin determination unit 402 outputs the detected spin state to the control register 421 and the spin state status register 422. The cache state signal 521 is a signal indicative of whether the state of the cache memory 103 has changed. Details of the cache state signal 521 will be described later with reference to FIG. 7.

The comparison circuit 501 compares the sensor I/F 404 with the sensor threshold storage register 423 and outputs a comparison result to the AND circuit 511 in the spin state detection circuit 431. For example, if the sensor signal from the sensor I/F 404 is greater than or equal to the value of the sensor threshold storage register 423, the comparison circuit 501 outputs TRUE as the comparison result. If the sensor signal from the sensor I/F 404 is less than the value of the sensor threshold storage register 423, the comparison circuit 501 outputs FALSE as the comparison result.

The determination circuit 502 determines whether an instruction executed by a program is a predetermined instruction, and outputs a determination result to the AND circuit 511 of the spin state detection circuit 431. In this case, the predetermined instruction is a jump instruction. Alternatively, the predetermined instruction may be an instruction acting as a jump instruction when the instruction is executed. For example, if there is an instruction to set a value of a general-purpose register or a value of a memory in the program counter 311, when the setting is performed, the execution position of the next instruction is defined as the set value and therefore, the same operation as the jump instruction is performed. Thus, an instruction to perform such an operation may be included as the predetermined instruction.

The determination circuit 503 determines whether the cache state signal 521 indicates the absence of a change in the cache state, and outputs a determination result to the extraction circuit 504. For example, the determination circuit 503 outputs TRUE as the determination result when the cache state signal 521 is a state signal indicative of the absence of a change in the cache state, and outputs FALSE as the determination result when the cache state signal 521 is a state signal indicative of the presence of a change in the cache state.

If the determination result is TRUE, the extraction circuit 504 extracts and outputs a jump destination address from the instructions accumulated in the issued instruction buffer 405 to the comparison circuit 506. For example, when an accumulated instruction is formed as a jump instruction+a jump destination address, the extraction circuit 504 extracts the jump destination address. If an accumulated instruction is an instruction to set an address of an offset value in a jump table in the program counter 311, the extraction circuit 504 extracts the address of the offset value in the jump table as the jump destination address.

The extraction circuit 505 extracts and outputs the jump destination address from the address pointed by the program counter 311 to the comparison circuit 506. A specific method of extracting the jump destination address is equivalent to that of the extraction circuit 504 and therefore will not be described.

The comparison circuit 506 compares the extraction results of the extraction circuit 504 and the extraction circuit 505 and outputs a comparison result to the AND circuit 511 of the spin state detection circuit 431. In this case, the predetermined instruction is a jump instruction. For example, the comparison circuit 506 outputs TRUE as the comparison result if the extraction results of the extraction circuit 504 and the extraction circuit 505 are the same jump address, and outputs FALSE if the extraction results are different addresses.

The AND circuit 511 outputs the logical product of the comparison circuit 501 and the comparison circuit 506 to the OR circuit 512. The OR circuit 512 outputs the logical sum of the spin state setting field of the control register 421 and the AND circuit 511 to the spin state field of the control register 421 and the spin state status register 422.

The determination circuit 502 may make a determination after the comparison result of the comparison circuit 501 turns to TRUE. Although process load increases in the determination circuit 502 because of monitoring of the cache memory 103, the processing efficiency of the spin avoidance mechanism 104 can be improved by operating the determination circuit 502 when the comparison result of the comparison circuit 501 turns to TRUE.

FIG. 6 is a block diagram of an example of spin state cancelation detection by the spin determining unit 402. FIG. 6 depicts an example of a circuit used at the time of the spin state cancelation detection by the spin determining unit 402. The spin determining unit 402 uses the spin state cancelation circuit 432, a comparison circuit 601, a determination circuit 602, the spin state status register 422, and an AND circuit 603 to detect cancelation of a spin state. The spin state cancelation circuit 432 includes an OR circuit 611.

For the spin state cancelation detection, the spin determining unit 402 receives input from the control register 421, the sensor I/F 404, the sensor threshold storage register 423, and the cache state signal 521. The spin determining unit 402 outputs the detected spin state to the control register 421 and the spin state status register 422.

The comparison circuit 601 compares the sensor I/F 404 with the sensor threshold storage register 423 and outputs a comparison result to the OR circuit 611 in the spin state cancelation circuit 432. For example, if the sensor signal from the sensor I/F 404 is less than the value of the sensor threshold storage register 423, the comparison circuit 601 outputs TRUE as the comparison result. If the sensor signal from the sensor I/F 404 is greater than or equal to the value of the sensor threshold storage register 423, the comparison circuit 601 outputs FALSE as the comparison result.

The determination circuit 602 determines whether the cache state signal 521 indicates the presence of a change in the cache state, and outputs a determination result to the AND circuit 603. For example, the determination circuit 602 outputs TRUE as the determination result when the cache state signal 521 is a state signal indicative of the presence of a change in the cache state, and outputs FALSE as the determination result when the cache state signal 521 is a state signal indicative of the absence of a change in the cache state.

The AND circuit 603 outputs the logical product of the determination circuit 602 and the spin state status register 422 to the OR circuit 611. For example, if the output signal from the determination circuit 602 is TRUE and the spin state status register 422 is TRUE indicative of a spin state, the AND circuit 603 outputs TRUE to the OR circuit 611. The OR circuit 611 outputs the logical sum of the spin state cancelation setting field of the control register 421, the comparison result from the comparison circuit 601, and the AND circuit 603 to the spin state field of the control register 421 and the spin state status register 422.

FIG. 7 is an explanatory view of an operation example of the cache memory state monitoring circuit 403. The cache memory 103 includes an instruction cache 701 and a data cache 702. If the snoop mechanism 301 is in operation, the cache memory state monitoring circuit 403 outputs as the cache state signal 521, a state signal indicating that the state of the cache memory 103 has changed. If the snoop mechanism 301 is not in operation, the cache memory state monitoring circuit 403 outputs as the cache state signal 521, a state signal indicating that the state of the cache memory 103 has not changed.

If the state of the cache memory 103 has not changed, the cache memory state monitoring circuit 403 acquires and stores into the issued instruction buffer 405, an instruction issued from the program counter 311.

The operation of the cache memory state monitoring circuit 403 in the case of issuance of a jump instruction will be described with reference to FIG. 7. When the jump instruction of an address 0x0012 in a first loop is executed, the instruction cache 701 has no instruction and therefore, the CPU #0 reads and executes an instruction from the memory 302. On the other hand, the CPU #0 stores the read instruction into the instruction cache 701.

Because of a short section from the address 0x0012 to the address 0x0000, it is assumed that when the CPU #0 executes the jump instruction of the address 0x0012, an instruction is hit in the instruction cache 701 from the second time on.

When the jump instruction of the address 0x0012 in a second or subsequent loop is executed, the CPU #0 acquires and executes the instruction hit in the instruction cache 701. In this case, since the state of the cache memory 103 has not changed, the cache memory state monitoring circuit 403 acquires a corresponding instruction “Jump 0x0000” from the address 0x0012 pointed to by the program counter 311. After the acquisition, the cache memory state monitoring circuit 403 stores into the issued instruction buffer 405, “Jump” and the jump destination address “0x0000” as the jump instruction.

When the jump instruction of the address 0x0012 in a third or subsequent loop is executed, the CPU #0 acquires and executes the instruction hit in the instruction cache 701. From the third time on, the extraction circuit 504 extracts and outputs the jump destination address to the comparison circuit 506 and the comparison circuit 506 compares the extraction circuit 504 with the extraction circuit 505 and outputs TRUE as a result.

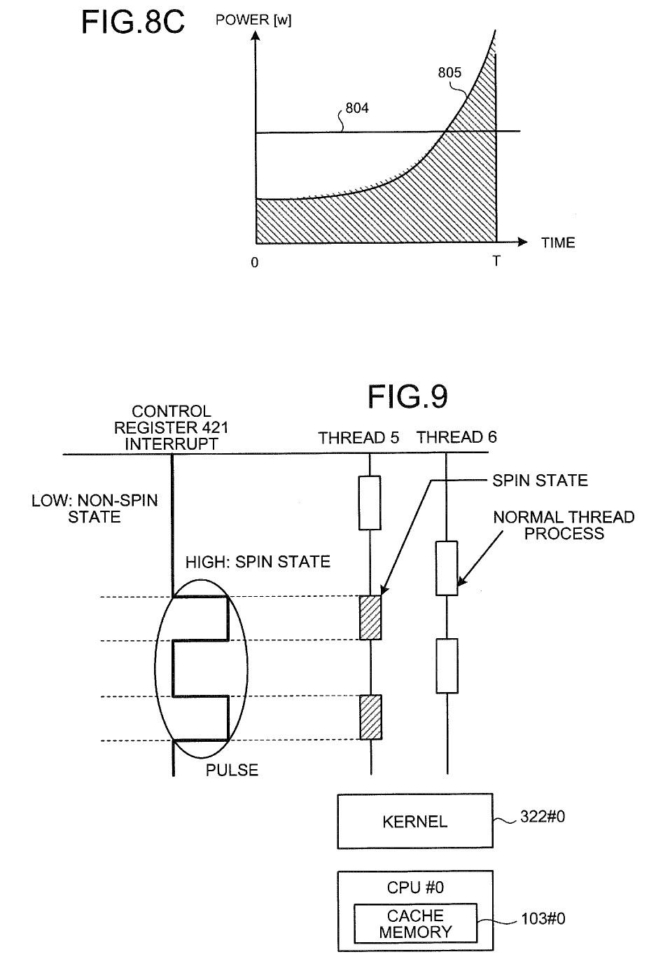

With the hardware and the operation depicted in FIGS. 4 to 7, the spin avoidance mechanism 104 performs the detection of the spin state and the cancelation of the detection of the spin state. An electric power characteristic in the case of the spin state and a method of determining the timing of elimination of the spin state will be described with reference to FIGS. 8A, 8B, 8C and 9.

FIGS. 8A, 8B, and 8C are explanatory views of an example of a power consumption state in the spin state. FIG. 8A depicts an example of threads entering the spin state in the multi-core processor system 100; FIG. 8B depicts an equation of the electric power characteristic, and FIG. 8C depicts a graph representative of a characteristic of power consumption of the CPU in the spin state.

The multi-core processor system 100 depicted in FIG. 8A executes threads 1 and 2 that belong to a parallel app and threads 3 and 4 that belong to other apps. The CPU #0 executes the threads 1 and 3 and the CPU #1 executes the threads 2 and 4. In this case, it is assumed that the thread 1 executes an exclusive control process due to an instruction of the thread 2.

It is assumed that in the exclusive control process by the thread 1, a state transition wait through monitoring of a flag is performed. In this case, the thread 1 reads a flag 1 to determine whether the flag satisfies a condition and, if not satisfying the condition, the thread 1 reads the flag 1 again. When such an operation is performed, the CPU continues executing instructions such as Load, Compare, and Jump. Since the instructions are stored in the cache memory 103, the time for fetching the instructions is minimized and causes an arithmetic unit of the CPU to continuously operate and therefore, the CPU falls into the spin state. Since the CPU behaves as if the CPU is executing an enormous amount of operations at highest efficiency at high speed, the CPU falls into the state of maximum power consumption.

FIG. 8B depicts an equation of the electric power characteristic in the spin state. If one thread is in the spin state while N threads are in operation in a CPU, the probability of the occurrence of the spin state of the CPU is 1/N. A time of the spin state of the CPU per unit time is 1/N [sec]. If the electric power characteristic in the spin state is denoted by p(t), energy consumption by the CPU is expressed by equation (1):

energy consumption=∫^{1/N}p(t) [J/sec] (1)

The value of Equation (1) becomes smaller in the case of a lower-frequency CPU and a chip with a longer instruction read latency. Conversely, if a process of software with a longer arithmetic column is executed, the value of (1) may become larger.

The graph in FIG. 8C represents the characteristics of power consumption of the CPU. The horizontal axis of the graph indicates time and the vertical axis indicates power. The electric power characteristic 804 represents the electric power characteristic at the time of operation of an operation instruction unit of the CPU and the electric power characteristic 805 represents the electric power characteristic in the spin state due to issuance of a Jump/Compare instruction of the CPU. The electric power characteristic 804 is substantially constant. The reason is that since an operation instruction is followed by a process requiring latency such as load/store of a memory, excitation and stand-by are repeated until one operation process is completed rather than allowing electricity to always flow in the CPU. Therefore, even if power consumption is high at a single time, the power does not increase at an accelerated rate even in the case of continuous execution.

Although the electric power characteristic 805 initially indicates the power lower than the electric power characteristic 804, the power consumption increases at an accelerated rate. The reason is that since the Jump/Compare instruction only causes processes such as rewriting the program counter 311 and performing logical comparison at an initial stage, the electric power characteristic 805 indicates the power lower than the electric power characteristic 804.

However, as the time elapses, since the jump instruction is a single instruction that can be operated one-by-one, the CPU always operates with a given clock period without requiring a latency. As a result, the CPU highly densely executes the instruction, resulting in a continuous excitation state and an increased temperature, and the increased temperature increases the power consumption due to a leak current.

With regard to specific methods of measuring the electric power characteristic 804 and the electric power characteristic 805, a program causing the CPU to perform simple calculations may be operated to measure a power value in this case for the electric power characteristic 804. Alternatively, a designer may acquire the characteristic from a design document and a data sheet of a processor. For the electric power characteristic 805, a code of Jump 0x0000 may be executed as an instruction code at the address 0x0000 to measure a power value.

Therefore, the spin state is not eliminated at the stage immediately after the start of the spin state because of the lower power consumption state and, if the energy consumption according to the power characteristic 805 exceeds the energy consumption according to the power characteristics 804, the spin state can be eliminated to suppress power consumption. For example, by eliminating the spin state at time T that is the solution of the following Equation (2), the CPU can improve the power efficiency.

∫tp(t)dt=Pc·t (2)

In Equation (2), Pc is the power consumption when the operation instruction unit is operated and Pc·t is energy consumption of the electric power characteristic 804. For example, Pc=40 [mW] is acquired. The value of Pc is stored in the sensor threshold storage register 423.

For example, it is assumed that the electric power characteristic p(t) of the CPU in this embodiment can be calculated by Equation (3).

p(t)=t²+30 [mW] (3)

The CPU can substitute Equation (3) in Equation (2) to acquire T=5.5 [msec]. Therefore, by eliminating the spin state when 5.5 [msec] have elapsed in the spin state, the CPU can improve the power efficiency. After solving Equation (2), the designer sets the time as a predetermined time, which is set in the spin avoidance mechanism driver 412.

FIG. 9 is an explanatory view of an example of a determining method of the timing of elimination of the spin state. As described with reference to FIG. 8, if the spin state exists for the predetermined time that is the solution of Equation (2) or longer, the spin state can be eliminated to improve the power efficiency. Description of a state in which the spin state repeatedly occurs will be made with reference to FIG. 9.

The CPU #0 depicted in FIG. 9 executes a thread 5 in the spin state and a thread 6 that is a normal thread process while dispatching the threads in a constant cycle. When such an operation is performed, the interrupt signal from the control register 421 is supplied as a pulse with a constant period. It is assumed that the spin state exists when the interrupt signal is HIGH and that the non-spin state exists when the interrupt signal is LOW.

For example, the CPU #0 may eliminate the spin state if a predetermined time is exceeded by an excitation width corresponding to a period while the interrupt signal is HIGH, and is further exceeded repeatedly for a predetermined number of times. As a result, the CPU #0 can refrain from eliminating the spin state in the case of a single spin state corresponding to transiently increased temperature and one pulse. With regard to a method of determining the predetermined number of times, a designer determines the predetermined number of times in advance based on electric power characteristics of the CPU, profiling results, etc. In the example of FIG. 9, two pulses are generated. If the excitation width of one pulse is greater than or equal to the predetermined time and the predetermined number of times is two, the CPU #0 eliminates the spin state.

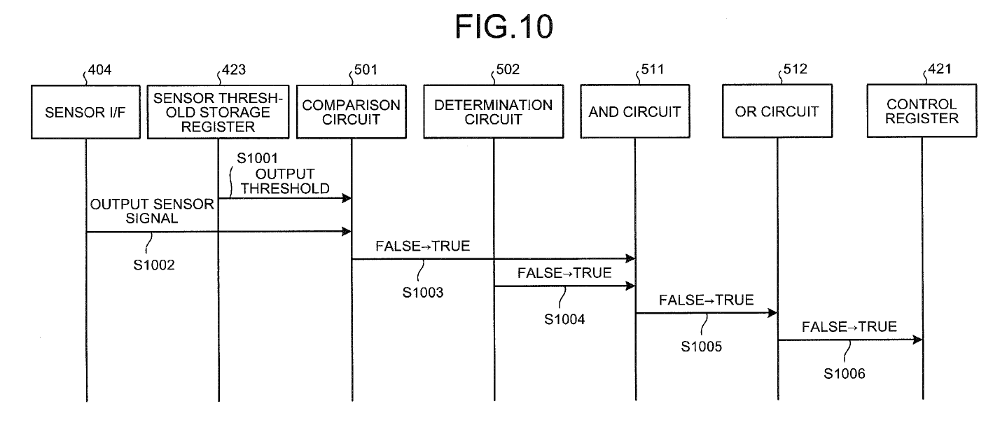

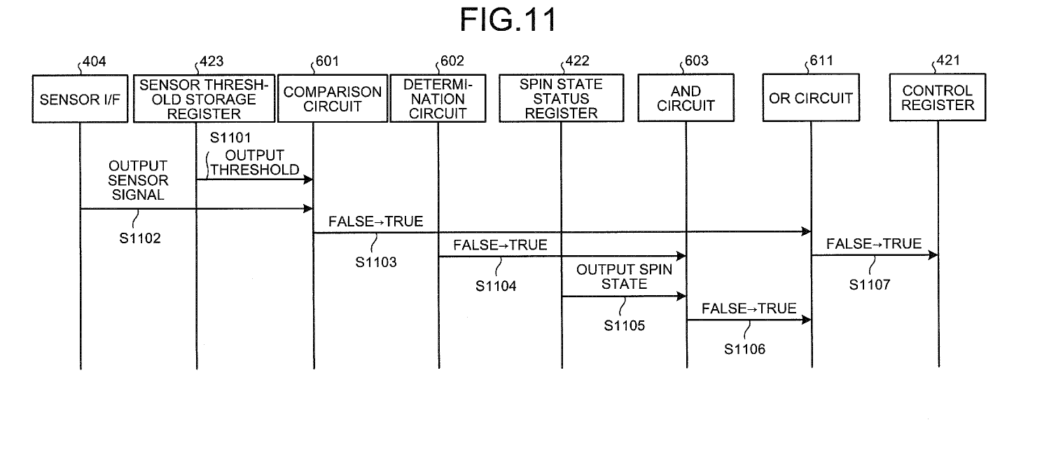

Sequence diagrams of FIGS. 10 and 11 depict sequences of the spin state detection determination and the spin state cancelation determination in the spin determining unit 402. In FIGS. 10 and 11, the spin avoidance mechanism 104# is assumed to make the determinations and the suffix “#0” will be omitted.

FIG. 10 is a sequence diagram of an example of the spin state detection determination. The sensor threshold storage register 423 outputs a threshold to the comparison circuit 501 (step S1001). The sensor I/F 404 outputs a sensor signal to the comparison circuit 501 (step S1002). If the amount of electric power indicted by the sensor signal becomes greater than or equal to the threshold, the comparison circuit 501 changes the output signal to the AND circuit 511 from FALSE to TRUE (step S1003). If it is determined that an instruction executed by the program is a jump instruction, the determination circuit 502 changes the output signal to the AND circuit 511 from FALSE to TRUE (step S1004).

The AND circuit 511 outputs the logical product of the comparison circuit 501 and the comparison circuit 506 to the OR circuit 512 (step S1005). For example, if the comparison circuit 501 executes step S1003 and the determination circuit 502 executes step S1004, the AND circuit 511 changes the output signal to the OR circuit 512 from FALSE to TRUE. If step S1005 is executed, the OR circuit 512 changes the output signal to the spin state field of the control register 421 from FALSE to TRUE (step S1006).

FIG. 11 is a sequence diagram of an example of the spin state cancelation determination. The sensor threshold storage register 423 outputs a threshold to the comparison circuit 601 (step S1101). The sensor I/F 404 outputs a sensor signal to the comparison circuit 601 (step S1102). If an amount of electric power indicted by the sensor signal becomes less than the threshold, the comparison circuit 601 changes the output signal to the OR circuit 611 from FALSE to TRUE (step S1103).

If the cache state is changed, the determination circuit 602 changes the output signal to the AND circuit 603 from FALSE to TRUE (step S1104). The spin state status register 422 outputs the spin state to the AND circuit 603 (step S1105). For example, the spin state status register 422 outputs TRUE to the AND circuit 603 in the case of the spin state and outputs FALSE to the AND circuit 603 in the case of the non-spin state.

The AND circuit 603 outputs the logical product of the determination circuit 602 and the spin state status register 422 to the OR circuit 611 (step S1106). For example, if the determination circuit 602 executes step S1004 and the spin state status register 422 executes step S1105, the AND circuit 603 changes the signal to the OR circuit 611 from FALSE to TRUE.

The OR circuit 611 outputs the logical sum of the comparison circuit 601 and the AND circuit 603 to the spin state field of the control register 421 (step S1107). For example, if the comparison circuit 601 executes step S1103 or if the AND circuit 603 executes step S1106, the OR circuit 611 changes the output signal to the spin state field of the control register 421 from FALSE to TRUE.

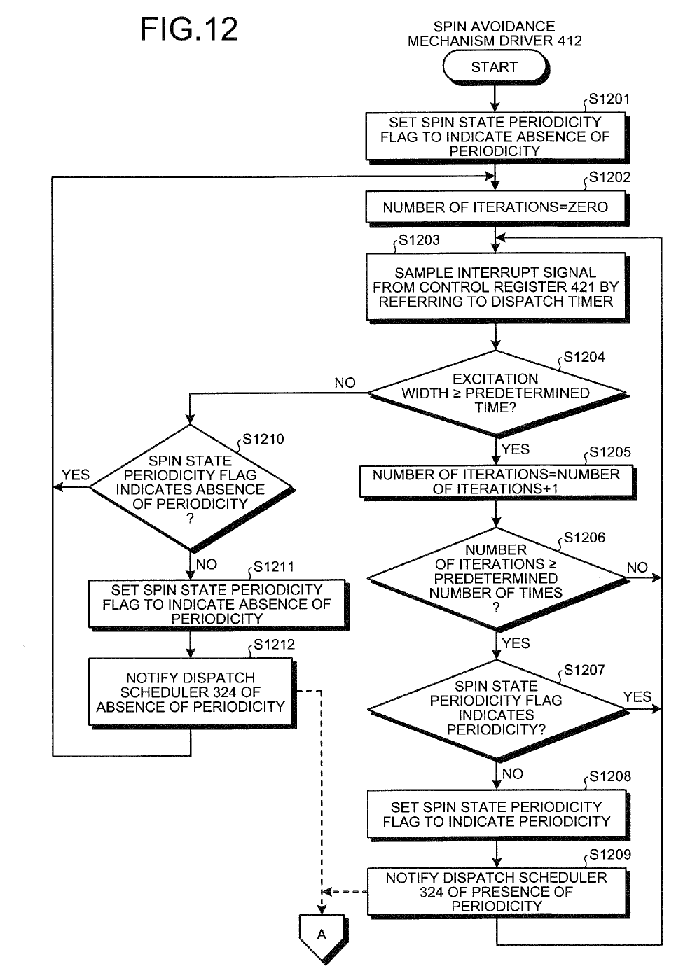

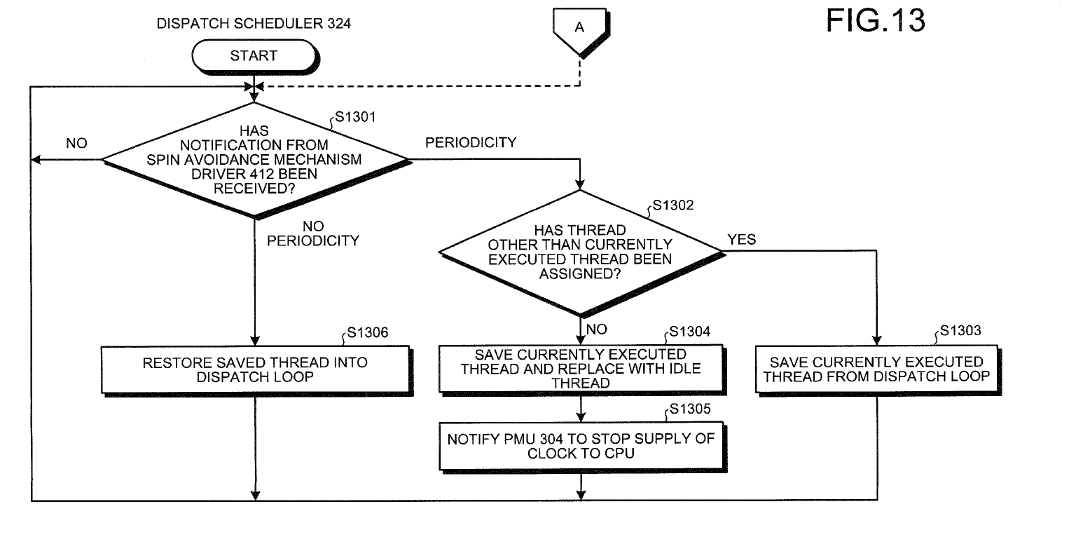

FIGS. 12 and 13 are flowcharts executed by the CPU #0. In FIG. 12, the CPU #0 executes a spin state periodicity determination process with the function of the spin avoidance mechanism driver 412#0; and in FIG. 13, the CPU #0 executes a thread save/restore process with the function of the dispatch scheduler 324#0. In FIGS. 12 and 13, the CPU #0 is assumed to execute the processes and the suffix “#0” will be omitted.

FIG. 12 is a flowchart of an example of the spin state periodicity determination process by the spin avoidance mechanism driver 412. The spin avoidance mechanism driver 412 sets a spin state periodicity flag to indicate the absence of periodicity (step S1201). After the setting, the spin avoidance mechanism driver 412 sets the number of iterations to zero (step S1202) and samples the interrupt signal from the control register 421 by referring to a dispatch timer (step S1203). For example, the spin avoidance mechanism driver 412 continuously monitors the interrupt signal for several tens of times of a time indicated by the dispatch timer to generate a waveform of the interrupt signal.

After the sampling, the spin avoidance mechanism driver 412 determines whether an excitation width is greater than or equal to a predetermined time (step S1204). If the excitation width is greater than or equal to the predetermined time (step S1204: YES), the spin avoidance mechanism driver 412 increments the number of iterations (step S1205) and determines whether the number of iterations is greater than or equal to a predetermined number of times (step S1206). If the number of iterations is less than the predetermined number of times (step S1206: NO). The spin avoidance mechanism driver 412 proceeds to the operation at step S1203.

If the number of iterations is greater than or equal to the predetermined number of times (step S1206: YES), the spin avoidance mechanism driver 412 determines whether the spin state periodicity flag indicates the presence of periodicity (step S1207). If the flag indicates the presence of periodicity (step S1207: YES), the spin avoidance mechanism driver 412 proceeds to the operation at step S1203. If the flag indicates the absence of periodicity (step S1207: NO), the spin avoidance mechanism driver 412 sets the spin state periodicity flag to indicate the presence of periodicity (step S1208). After the setting, the spin avoidance mechanism driver 412 notifies the dispatch scheduler 324 of the presence of periodicity (step S1209) and proceeds to the operation at step S1203.

If the excitation width is less than the predetermined time (step S1204: NO), the spin avoidance mechanism driver 412 determines whether the spin state periodicity flag indicates the absence of periodicity (step S1210). If the flag indicates the absence of periodicity (step S1210: YES), the spin avoidance mechanism driver 412 proceeds to the operation at step S1202. If the flag indicates the presence of periodicity (step S1210: NO), the spin avoidance mechanism driver 412 sets the spin state periodicity flag to indicate the absence of periodicity (step S1211). After the setting, the spin avoidance mechanism driver 412 notifies the dispatch scheduler 324 of the absence of periodicity (step S1212) and proceeds to the operation at step S1202.

As a result, when the excitation width is greater than or equal to the predetermined time and the spin state and the non-spin state are repeated a predetermined number of times, the spin avoidance mechanism driver 412 can determine the presence of periodicity.

FIG. 13 is a flowchart of an example of the thread save/restore process by the dispatch scheduler 324. The dispatch scheduler 324 determines whether notification from the spin avoidance mechanism driver 412 has been received (step S1301). If not (step S1301: NO), the dispatch scheduler 324 executes the operation at step S1301 again after a certain time has elapsed.

If notification of the presence of periodicity has been received (step S1301: PERIODICITY), the dispatch scheduler 324 determines whether another thread other than a currently executed thread has been assigned (step S1302). If another thread has been assigned (step S1302: YES), the dispatch scheduler 324 saves the currently executed thread from a dispatch loop (step S1303) and proceeds to step S1301.

If no other thread has been assigned (step S1302: NO), the dispatch scheduler 324 saves the currently executed thread and replaces the thread with an idle thread (step S1304). After the replacement, the dispatch scheduler 324 notifies the PMU 304 to stop the supply of the clock to the CPU (step S1305) and proceeds to the operation at step S1301.

If notification of the absence of periodicity has been received (step S1301: NO PERIODICITY), the dispatch scheduler 324 restores the saved thread into the dispatch loop (step S1306) and proceeds to the operation at step S1301. If multiple threads are saved, the dispatch scheduler 324 restores all the saved threads into the dispatch loop.

As a result, the dispatch scheduler 324 can save the thread that causes the spin state. If the non-spin state occurs, the dispatch scheduler 324 can restore the thread to continue the saved thread.

For example, the steps depicted in the flowcharts are operations implemented by causing the CPUs 201 to execute a search program stored in a storage device such as the ROM 202, the RAM 203, the flash ROM 204, and the flash ROM 206 depicted in FIG. 2. An execution result of each execution is written into the storage device and read out in response to a read request from another process.

As described above, according to the system and the detection method, a detection circuit is included that uses a sensor signal from a sensor that detects power and a state signal from a cache memory state monitoring circuit that detects the state of a cache memory to detect a spin state of a program. As a result, the system can use a state of the system in the spin state such as the power of the CPU and a change in state of the cache memory as a detection condition of the spin state, thereby detecting the spin state occurring consequent to a program that is implemented without using an instruction for exclusive control.

The detection of the spin state is preferably performed by using a combination of the signal from the sensor and the state signal from the cache memory state monitoring circuit. The reason is that if the spin state is detected by using only the signal from the sensor, when a mobile terminal having the system is put into a pocket of a user, accumulated heat may increase power consumption despite the non-spin state. As for the case of detecting the spin state by using only the state signal of the cache memory, the reason is that if a program implemented without rewrite of an instruction cache is executed, a state is achieved in which the state does not change even in the non-spin state.

The system according to this embodiment does not perform memory access at the time of detection of the spin state and detection of the spin state cancelation and therefore, the system can detect, with almost no load, a spin state that cannot be detected by conventional techniques.

The system may include a cancelation circuit that cancels the spin state of the program when the spin state is detected. As a result, even if the system once falls into the spin state, the system can transition to the non-spin state.

The system may compare the sensor signal with a threshold and output the comparison result to the detection circuit. As a result, since it may be considered that the spin state causes the arithmetic unit of the CPU to continuously operate and increase power consumption and temperature, the system can output the possibility of the occurrence of the spin state to the detection circuit.

The system may determine whether an instruction executed by the program is a predetermined instruction and outputs the determination result to the detection circuit. The predetermined instruction may be a jump instruction or may be an instruction for loading an address of a jump table to a program counter. As a result, since the continuous execution of the same jump instruction is detected, the system can output the possibility of the occurrence of the spin state to the detection circuit.

The system may retain in a control register that includes information for controlling the program executed by the CPU based on the detection result of the detection circuit. As a result, by referring to the control register, the CPU can acquire whether the spin state or the non-spin state occurs.

If the sensor signal is greater than or equal to the threshold and the state of the cache memory does not change, the system may detect the spin state. As a result, since the system detects that power consumption is eventually accelerated due to the spin state and also detects that the same instruction is continuously executed without a change in the cache memory due to the spin state, the system can identify the presence of the spin state.

If the state of the cache memory does not change and the instruction of the program is a predetermined instruction, the system may detect the spin state. As a result, since the system detects that the predetermined instruction, i.e., the jump instruction, is repeatedly executed, the system can identify the presence of the spin state.

When the sensor signal is less than a threshold or if the state of the cache memory is changed during the spin state, the system may detect the non-spin state. As a result, since at least one of the spin state detection conditions is eliminated, the system can identify the presence of the non-spin state.

If the spin state is detected, the system may cancel the spin state by replacing the process corresponding to the spin state with a predetermined process. The predetermined process is the idle thread. As a result, the system can cancel the state in which the spin state causes power consumption to increase at an accelerated rate, and can improve the power efficiency.

If the time during the spin state is greater than or equal to a predetermined time, the system may terminate the assignment of the process corresponding to the spin state. For example, a flag condition is rapidly satisfied in some thread even when the spin state occurs and if such a thread is saved, the processing performance deteriorates by saving and restoring the process relative to the timing at which the spin state should originally immediately be canceled. Since the power consumption immediately after the occurrence of the spin state is lower as compared to a typical arithmetic unit, if the assignment of the process is terminated immediately after the occurrence of the spin state, power consumption increases. Therefore, by terminating the assignment of the process if the spin state continues for a predetermined time set in advance or longer, the system can maintain the process performance and can improve power efficiency.

If the time during the spin state is greater than or equal to a predetermined time and the number of iterations of the spin state and the non-spin state is greater than or equal to a predetermined number, the system may terminate the assignment of the process corresponding to the spin state. For example, if the assignment of the process is terminated while the number of iterations is smaller, the system can reduce an excessive supply state of power; however, the numbers of times of the termination of process assignment and the restoration of assignment are increased and therefore, the overhead required for the termination and the restoration increases. Therefore, by terminating the assignment of the process when the number of iterations is greater than or equal to the predetermined number of times set in advance, the system can improve power efficiency while suppressing the overhead required for the termination and the restoration.

For example, if the system according to a conventional example performs I/O exclusive lock of a transmission control protocol (TCP) packet buffer, the number of iterations of the spin state is from several thousands to several millions of times. Therefore, if the system according to this embodiment sets the predetermined number of times to several tens of times and terminates the assignment of the process corresponding to the spin state when the spin state and the non-spin state are repeated a predetermined number of times, power efficiency can be improved as compared to a system according to a conventional example.

The detection method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

The spin avoidance mechanism 104 described in the present embodiment can be implemented by an application specific integrated circuit (ASIC) such as a standard cell or a structured ASIC, or a programmable logic device (PLD) such as a field-programmable gate array (FPGA). Specifically, for example, functional units (storage unit 401 to issued instruction buffer 405) of the spin avoidance mechanism 104 are defined in hardware description language (HDL), which is logically synthesized and applied to the ASIC, the PLD, etc., thereby enabling manufacture of the spin avoidance mechanism 104.

According to an aspect of the embodiments, a spin state that occurs consequent to a loop not explicitly described in a program can be detected.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A system comprising:
a CPU;
a sensor that detects power of the CPU;
a cache memory state monitoring circuit that monitors a state of a cache memory; and
a detection circuit that based on a sensor signal from the sensor and a state signal from the cache memory state monitoring circuit, detects a spin state of a program executed by the CPU.

2. The system according to claim 1, further comprising
a cancelation circuit that cancels the spin state of the program when the spin state is detected.

3. The system according to claim 1, further comprising
a comparison circuit that compares the sensor signal with a threshold and outputs a comparison result to the detection circuit.

4. The system according to claim 1, further comprising
a determination circuit that determines whether an instruction executed by the program is a predetermined instruction and outputs a determination result to the detection circuit.

5. The system according to claim 4, wherein
the predetermined instruction is a jump instruction.

6. The system according to claim 1, further comprising
a control register that stores information for controlling the program based on a detection result of the detection circuit.

7. A system comprising:
a CPU;
a sensor that detects power of the CPU and outputs a sensor signal; and
a cache memory state monitoring circuit that monitors a state of a cache memory and outputs a state signal, wherein
when the sensor signal is at least equal to a threshold and the state signal indicates that the state of the cache memory has not changed, a spin state of a program executed by the CPU is detected.

8. The system according to claim 7, wherein
when the state signal indicates that the state of the cache memory has not changed and an executed instruction of the program is a predetermined instruction, the spin state is detected.

9. The system according to claim 7, wherein
when the sensor signal is less than the threshold, or when the state signal indicates that the state of the cache memory has changed in a case of the spin state, a non-spin state is detected.

10. A detection method comprising:
detecting power of a CPU;
monitoring a state of a cache memory; and
detecting based on the detected power and the state of the cache memory, a spin state of a program executed by the CPU.

11. The detection method according to claim 10, wherein
the detecting includes detecting whether the power is at least equal to a threshold, where if the power is at least equal to the threshold, the spin state is detected, and if the power is less than the threshold, detection of the spin state is not performed.

12. The detection method according to claim 10, further comprising
replacing, when the spin state is detected, a process corresponding to the spin state with a predetermined process to cancel the spin state.

13. The detection method according to claim 12, further comprising
terminating, when a time during the spin state is at least equal to a predetermined time, assignment of the process corresponding to the spin state.

14. The detection method according to claim 13, wherein
the terminating of the assignment includes terminating assignment of the process corresponding to the spin state, when a count of iterations of the spin state and a non-spin state is at least equal to a predetermined number.
